(19) United States
(12) Patent Application Publication
(10) Pub. No.: US 2010/0300085 A1
(43) Pub. Date: Dec. 2, 2010

(54) DRIVE SYSTEM

(76) Inventors: Peter Schmuttermair, Gessertshausen (DE); Matthias Mueller, Neusaess (DE)

Correspondence Address: MICHAEL J. STRIKER, 103 EAST NECK ROAD, HUNTINGTON, NY, 11743, US

(21) Appl. No.: 12/744,757

(22) PCT Filed: Dec. 22, 2008
(86) PCT No.: PCT/EP08/11028

§ 371 Date: May 26, 2010

(30) Foreign Application Priority Data
Dec. 28, 2007 (DE) 10 2007 062 889.9

(51) Int. Cl. F15B 1/027

(52) U.S. Cl. 60/414

(57) ABSTRACT

The invention relates to a drive system (1) having a travel drive, a working hydraulic system (3) and a device for hydrostatic braking (4). The device for hydrostatic braking has a first hydrostatic piston machine (12) which is connected to a drive train (2), wherein the first hydrostatic piston machine (12) is connected via an accumulator line (14) to a pressure accumulator (15) and the accumulator line (14) is connected via an accumulator pressure line (16) to the working hydraulic system (3). As an alternative, the drive system (100) additionally has a second hydrostatic piston machine (13) which is connected mechanically to the first hydrostatic piston machine (12), wherein the first hydrostatic piston machine (12) is connected in the closed circuit via the accumulator line (14) to the pressure accumulator (15), and the second hydrostatic piston machine is connected in the open circuit via a working line (16) to the working hydraulic system (3).

The present invention relates to a drive system for storing and reusing hydraulic energy and for exchanging energy between a drive train and a working hydraulic system.

Laid-open application DE 32 35 825 A1 shows a vehicle for at least one operation during at least one stopping period. The vehicle includes a mechanical main drive train, a working hydraulic system, and a device for hydrostatic braking. The device for hydrostatic braking includes a first hydrostatic device, which is connectable via a coupling to the mechanical main drive train, and a second hydrostatic device which is mechanically connectable to the first hydrostatic device. The first hydrostatic device is connectable via an accumulator line to a pressure accumulator. The second hydrostatic device is connectable via a working line to the working hydraulic system. The vehicle may draw energy from the main drive train and store it in the pressure accumulator. The energy may be drawn from the drive machine or the kinetic energy of vehicle. Energy that is stored in the pressure accumulator may be supplied to the main drive train and/or directly to the working hydraulic system. Energy from the main drive train is supplied via the first and second hydrostatic devices to the pressure accumulator. Energy from the pressure accumulator is likewise supplied via the first and second hydrostatic devices to the working hydraulic system. Energy that is stored in the pressure accumulator is supplied to the main drive train via at least one hydrostatic device.

In the vehicle that is proposed, it is disadvantageous that energy from the pressure accumulator is supplied to the working hydraulic system only during stopping periods. The working hydraulic system is therefore not supported by the pressure accumulator outside of the stopping periods. The stored energy is not reused in the working hydraulic system outside of the stopping periods. The vehicle that is proposed has the further disadvantage that the energy from the pressure accumulator is supplied directly to the working hydraulic system only via the second hydrostatic device. Due to this circuitous route, unnecessary energy losses occur when energy is transferred from the pressure accumulator to the working hydraulic system. The hydrostatic devices through which pressure medium flows during this energy transfer rotate and thereby produce friction and frictional heat. In addition, as a result, neither of the two hydrostatic devices is available to perform independent functions during this energy transfer.

The present invention is based on the object of creating a drive system that enables stored energy to be supplied to a working hydraulic system with minimal energy losses even outside of stopping periods.

The object is attained using the drive system having the features of claim 1.

The drive system according to the present invention includes a travel drive, a device for hydrostatic braking, and a working hydraulic system. The travel drive includes a drive train. The device for hydrostatic braking includes a first hydrostatic piston machine, which is connected to the drive train, and a pressure accumulator. The first hydrostatic piston machine is connected via an accumulator line to the first pressure accumulator. The working hydraulic system is connected via an accumulator pressure line to the accumulator line. The drive system according to the present invention thereby has the advantage that energy may be transferred from the drive train to the pressure accumulator and into the working hydraulic system, via a single hydrostatic piston machine in each case. The energy from the drive train may be drive energy or brake energy. This yields the advantage that energy may be supplied from the drive train to the working hydraulic system even outside of stopping periods. The drive system according to the present invention also has the advantage that energy may be transferred from the pressure accumulator to the working hydraulic system, directly via the accumulator pressure line, without taking a circuitous route through two hydrostatic piston machines. Unnecessary energy losses that occur due to friction caused by the rotation of a hydrostatic piston machine are thereby prevented. Due to the direct connection between the pressure accumulator and the working hydraulic system, an efficient transfer of energy from the pressure accumulator to the working hydraulic system is enabled, even outside the stopping periods.

Advantageous embodiments of the drive system according to the present invention are described in the dependent claims.

The first hydrostatic piston machine is preferably designed as a variable-displacement pump. Designing the first hydrostatic piston machine as a variable-displacement hydraulic pump has the advantage that the volume delivered by the first hydrostatic piston machine may be adjusted in a manner such that energy may be transferred simultaneously from the first hydrostatic piston machine and the pressure accumulator to the working hydraulic system. Due to the contribution made by the first hydrostatic piston machine, the pressure accumulator is drained more slowly. The situation is thereby prevented in which the pressure in the pressure accumulator is reduced unnecessarily. It is therefore possible to store energy in the pressure accumulator for a longer period of time, and/or to draw energy from the pressure accumulator for a longer period of time. The pressure accumulator may therefore be used more efficiently, and the primary working source may be operated in an improved range of efficiency. The simultaneous energy transfer from the first hydrostatic piston machine and from the pressure accumulator to the working hydraulic system has the advantage that it enables an energy supply from the drive train and from the pressure accumulator to be utilized simultaneously. It is therefore possible to protect the energy reserves in the pressure accumulator and to simultaneously utilize excess energy from the drive train. Excess energy of this type occurs in the drive train e.g. during braking. This excess energy may also occur at a point in time when the drive machine supplies more energy to the drive train than it requires at that moment to drive the vehicle.

Furthermore, it is advantageous to develop the first hydrostatic piston machine as a hydraulic pump that may be swung out in opposite directions, past a neutral position. Using the first hydrostatic piston machine as a hydraulic pump that may be swung out in opposite directions, past a neutral position, it is therefore possible to pump pressure medium in opposite directions by selecting opposing directions of rotation, or, conversely, to rotate in opposite directions by selecting identical pumping directions. As a result, the delivery-direction ratio may be reversed using hydraulic pumps that are connected by a common shaft, given a constant direction of rotation of the shaft.

In a preferred embodiment, a second hydrostatic piston machine is mechanically connected to the first hydrostatic piston machine, and is connected via a working pressure line to the working hydraulic system. The second piston machine is preferably likewise variably displaceable and is designed, in particular, to be operated in two pumping directions. The variable displaceability of at least one hydrostatic piston machine has the further advantage that the delivery-volume ratio between the two hydrostatic piston machines may be adjusted. Variable pressure boosting is thereby made possible. The second hydrostatic piston machine may pump pressure medium into the working hydraulic system. The energy required therefore is drawn by the second hydrostatic piston machine from the drive train and/or the by the first hydrostatic piston machine from the pressure accumulator.

In an advantageous embodiment, an accumulator pressure-maintaining valve is formed in the accumulator line.

This accumulator pressure-maintaining valve prevents the pressure accumulator from being drained unnecessarily. It is thereby ensured that energy stored in the pressure accumulator does not escape via the accumulator pressure-maintaining valve at an unfavorable point in time.

Particularly preferably, the accumulator pressure-maintaining valve, in its home position, is designed as a non-return valve that is open toward the pressure accumulator As a result, when the accumulator pressure-maintaining valve is in its home position, pressure medium and energy may be pumped via the accumulator pressure-maintaining valve into the energy accumulator, but it may not escape in the opposite direction.

In an advantageous embodiment, a pressure-limiting valve is formed in the accumulator pressure line. This pressure-limiting valve defines a first pressure-limiting value that must be exceeded in the pressure accumulator for the pressure accumulator to be drained via the pressure-limiting valve. As a result, the pressure accumulator is unable to supply energy and pressure medium to the working hydraulic system until a certain fill level or a certain pressure is reached.

Furthermore, it is advantageous to design this pressure-limiting valve as a controllable pressure-limiting valve. As a result, the first pressure-limiting value may be adjusted and dynamically adapted to the requirements. Optimal operation of the pressure accumulator and the working hydraulic system are therefore made possible.

In a preferred embodiment, the accumulator pressure line between the pressure-limiting valve and the working hydraulic system is connected via a tank line to a tank, a further pressure-limiting valve being formed in the tank line. Due to the tank line, the accumulator pressure line may be relieved of pressure in a region between the pressure-limiting valve and the working hydraulic system. The further pressure-limiting valve defines a second pressure-limiting value that must be exceeded in this region of the accumulator pressure line for the region of the accumulator pressure line to be relieved into the tank. As a result, a maximum pressure is defined for this region of the accumulator pressure line, and the working hydraulic system is prevented from being overloaded by the drive system. In addition, hydraulic braking may be implemented even when the accumulator is full.

In an advantageous embodiment, the accumulator pressure line between the branch of the tank line and the working hydraulic system are connected to a shuttle valve that connects the working hydraulic system to a further pressure medium source or to the branch. As a result, pressure medium and energy from the drive train, pressure accumulator, or, as an alternative, from a further pressure medium source, may be supplied to the working hydraulic system. The working hydraulic system may then be supplied with pressure medium and energy even when the amount of energy or pressure medium that is available to the drive train and the pressure accumulator is insufficient.

The object is likewise attained using the drive system having the features of claim 12.

The drive system includes a travel drive, a device for hydrostatic braking, and a working hydraulic system. The travel drive includes a drive train. The device for hydrostatic braking includes a first hydrostatic piston machine, which is connected via a coupling to the drive train, and a second hydrostatic piston machine which is mechanically connected to the first hydrostatic piston machine. The first hydrostatic piston machine is connected via an accumulator line to a pressure accumulator, and via a further accumulator line to a further pressure accumulator. The second hydrostatic piston machine is connected via a working line to the working hydraulic system. The first hydrostatic piston machine is situated in a closed circuit, and the second hydrostatic piston machine is situated in an open circuit. The drive system according to the present invention therefore has the advantage that energy and pressure medium may be supplied to the working hydraulic system even outside of stopping periods. The drive system according to the present invention also has the advantage that it may supply accumulated energy to the working hydraulic system even outside of stopping periods, and to the drive train, simultaneously in particular, it being possible to implement pressure boosting. A further advantage of the drive system according to the present invention is that it may supply accumulated energy to the working hydraulic system independently of the operating state of the drive train.

Advantageous embodiments of the alternative drive system according to the present invention are described in the dependent claims.

The first hydrostatic piston machine and/or the second hydrostatic piston machine are/is preferably a variable-displacement hydraulic pump. As a result, the delivery-volume ratio between the two hydrostatic piston machines may be adjusted in a variable manner. Variable pressure boosting is thereby made possible. If one of the pressure accumulators is full, the delivery volume of the first hydrostatic piston machine may be set to zero to prevent the full pressure accumulator from becoming overloaded. When the pressure accumulator that has the higher pressure is drained into the pressure accumulator that has the lower pressure, the first hydrostatic piston machine generates a torque. This torque may be adjusted in a variable manner via the delivery volumes of the first hydrostatic piston machine. If the delivery volume is swiveled to zero, the torque disappears. The variable displaceability of the second hydrostatic piston machine may be used to activate the delivery of pressure medium to the working hydraulic system in a variable manner. The pressure that is applied by the second hydrostatic piston machine to the working hydraulic system may be adjusted, using its delivery volumes, in a variable manner for a specified torque with which the second hydrostatic piston machine is driven.

Particularly preferably, the first hydrostatic piston machine and/or the second hydrostatic piston machine is a hydraulic pump that may be swung-out in opposite directions, past a neutral setting. As a result, the delivery-direction ratio of the hydraulic pumps, which are connected by a common shaft, may be reversed given a constant direction of rotation of the shaft. Advantageously, the contribution, and its sign, of the delivery-volume ratio between the two hydraulic pumps may be adjusted. It is therefore possible to deliver energy from the drive train to a pressure accumulator and the working hydraulic system simultaneously. It is likewise possible to deliver energy from a pressure accumulator to the drive train and the working hydraulic system simultaneously. In particular, it is possible to switch between energy accumulation and the reutilization of energy without having to change the direction of rotation of the shaft that is common to both hydraulic pumps.

The pressure accumulator is preferably designed as a high-pressure accumulator, and the further pressure accumulator is preferably designed as a low-pressure accumulator. As a result, a closed hydraulic circuit is realized for the first piston machine, in which energy may be accumulated, and from which energy may be drawn.

In an advantageous embodiment, the working pressure line is connected via a tank line to a tank, and a pressure-limiting valve is formed in the tank line. A region of the working pressure line that is connected to the tank line may therefore be relieved via the tank line. The pressure-limiting valve defines a limit pressure that must be exceeded in the first region of the working pressure line for the first region of the working pressure line to be relieved into the tank. As a result, a maximum pressure is defined for the region of the working pressure line that is connected to the tank line. The working hydraulic system is thereby prevented from being overloaded by the drive system.

Particularly preferably, a shuttle valve is connected in the working pressure line between the branch to the tank line and the working hydraulic system, and connects the working hydraulic system to a further pressure medium source or to the branch. As a result, pressure medium and energy from the drive train, pressure accumulator, or, as an alternative, from a further pressure medium source, may be supplied to the working hydraulic system. In addition, the working hydraulic system may then be supplied with pressure medium and energy even when the amount of energy or pressure medium that is available to the drive train and the pressure accumulator is insufficient.

An accumulator pressure-maintaining valve is preferably formed in the supply line. The accumulator pressure-limiting valve prevents the pressure accumulator from draining via the accumulator pressure-maintaining valve at an unfavorable point in time. It is thereby ensured that energy stored in the pressure accumulator does not escape via the accumulator pressure-maintaining valve.

Particularly preferably, the accumulator pressure-maintaining valve, in its home position, is designed as a non-return valve that is open toward the pressure accumulator When the accumulator pressure-maintaining valve is in its home position, pressure medium and energy may be pumped via the accumulator pressure-maintaining valve into the energy accumulator, but it may not escape in the opposite direction.

The embodiments of the drive system according to the present invention, which were described above, are suitable for use in particular for operating garbage trucks and presses in garbage trucks or other vehicles that include a working hydraulic system and intensive driving cycles.

Preferred embodiments of the drive system according to the present invention are presented in the drawing and are described in greater detail with refererent to the description that follows. In the drawings:

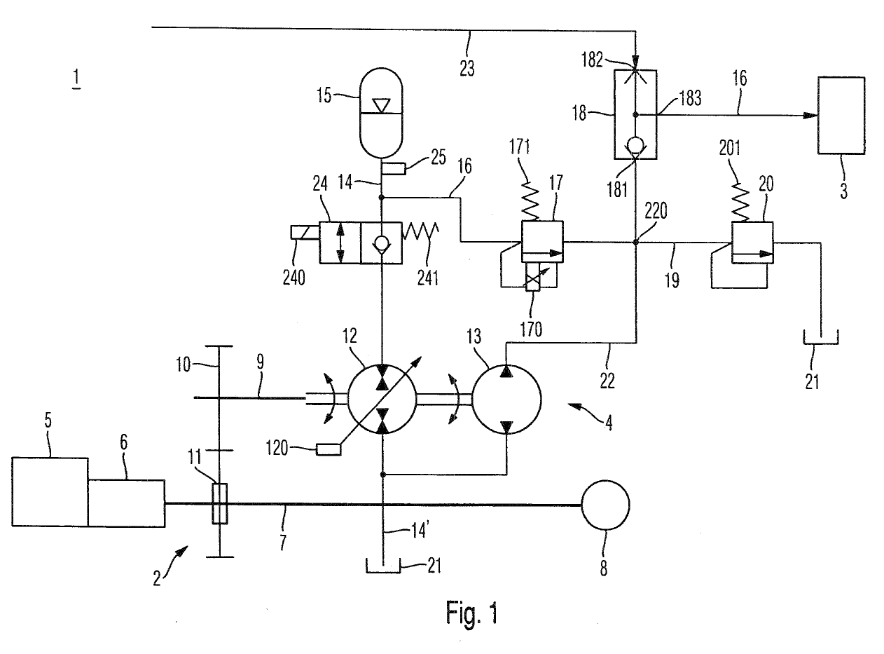

FIG. 1 shows a circuit diagram of a first embodiment of the drive system according to the present invention, and

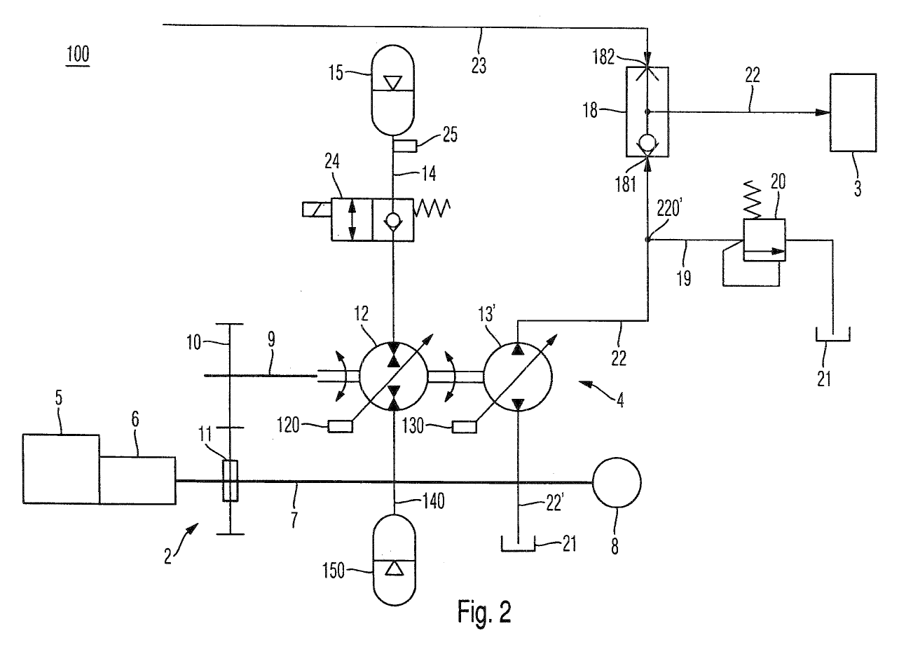

FIG. 2 shows a circuit diagram of a second embodiment of the drive system according to the present invention that includes an open circuit and a closed circuit.

FIG. 1 shows a drive system 1, according to the present invention, including a mechanical drive train 2, a working hydraulic system 3, and a device for hydrostatic braking 4. Mechanical drive train 2 includes a diesel engine 5, a main transmission 6, a first drive shaft 7, and a rear axle transmission 8. Diesel engine 5 may be replaced by any type of drive machine. Main transmission 6 may include mechanical and/or hydraulic components. Rear axle transmission 8 may be replaced by another torque and energy consumer. A second drive shaft 9 is connected to a gear stage 10. Gear stage 10 is connected via a clutch 11 to first drive shaft 7. In all, first drive shaft 7 is detachably connected to second drive shaft 9 via clutch 11. Second drive shaft 9 is connected to a first hydraulic pump 12 and a second hydraulic pump 13. First hydraulic pump 12 may be swung out in opposite directions, past a neutral position. First hydraulic pump 12 is connected to an accumulator line 14. Accumulator line 14 connects hydraulic pump 12 to a pressure accumulator 15. First hydraulic pump 12 is also connected via a suction line 14′ to a tank volume 21. An accumulator pressure-maintaining valve 24 is installed in accumulator line 14 between first hydraulic pump 12 and first pressure accumulator 15. Accumulator pressure-maintaining valve 24 may assume various positions, is adjustable, and includes a spring 241. The various positions of accumulator pressure-maintining valve 24 may be activated against the force of spring 241 by an actuator 240. Accumulator line 14 is connected via an accumulator pressure line 16 to working hydraulic system 3.

A pressure-limiting valve 17 is located in accumulator pressure line 16. Pressure-limiting valve 17 is designed as a pressure control valve having proportional activation, but it may also be replaced by another pressure-limiting valve. Pressure control valve 17 ensures that second hydraulic pump 13 has minimum back-pressure for the braking function. Pressure control valve 17 opens when the pressure in first pressure accumulator 15 exceeds a first pressure limit value. In the open state, pressure medium may flow via pressure-limiting valve 17 in the direction of working hydraulic system 3.

The first pressure limit value is defined using first spring 171. Pressure-limiting valve 17 is likewise adjustable, by generating an adjustable counterforce using an actuator 171. As a result, the first pressure limit value may be adjusted. In a simpler embodiment, pressure-limiting valve 17 may be replaced by a non-adjustable pressure-limiting valve. In addition, a shuttle valve 18 is connected to accumulator pressure line 16 between pressure-limiting valve 17 and working hydraulic system 3. Shuttle valve 18 includes a first inlet 181, a second inlet 182, and an outlet 183. Shuttle valve 18 only connects inlet 181 or 182 to which the higher pressure is applied to outlet 183. First inlet 181 is connected to a branch 220. Second inlet 182 is connected to further pressure medium source 23. Outlet 183 is connected via a section of accumulator pressure line 16 to working hydraulic system 3 on the output side. Accumulator pressure line 16 is connected via a working line 22 to second hydraulic pump 13. Second hydraulic pump 13 is connected via a connecting line to suction line 14′ and, therefore, to tank volume 21. Working line 22 and accumulator pressure line 16 are connected to each other and to a tank line 19. In the embodiment shown, accumulator pressure line 16, working line 22, and tank line 19 are connected to each other via branch 220. Tank line 19 connects working line 22 to tank 21. A further pressure-limiting valve 20 is installed in tank line 19. Further pressure-limiting valve 20 opens only when the pressure in working line 22 exceeds a second pressure limit value that is higher than the first pressure limit value. The second pressure limit value is defined by further pressure-limiting valve 20 using second spring 201. Further pressure-limiting valve 20 is not adjustable, but it may likewise be replaced by an adjustable high-pressure limiting valve.

First hydraulic pump 12 is connected to a first adjusting device 120 for adjusting the displacement volume and delivery direction of first hydraulic pump 12. Pressure-limiting valve 17 includes an actuator, e.g., a proportional magnet 170, and accumulator pressure-maintaining valve 24 likewise includes an actuator e.g. a further proportional magnet 240. Pressure accumulator 15 is connected to a pressure sensor 25 that measures the pressure present in pressure accumulator 15. First adjusting device 120, proportional magnet 170, and pressure sensor 25 are connected to a not-shown system for energy management. The system for energy management measures the pressure that is present in pressure accumulator 15, using pressure sensor 25, and activates first hydraulic pump 12 using first adjusting device 120, pressure-limiting valve 17, and proportional magnet 170, and activates accumulator pressure-maintaining valve 24 using further proportional magnet 240.

If the pressure in pressure accumulator 15 is lower than the first pressure limit value, pressure-limiting valve 17 is closed. However, if the pressure in pressure accumulator 15 is higher than the first pressure limit value, pressure-limiting valve 17 is opened. The first pressure limit value of pressure-limiting valve 17 is adjustable.

If the pressure in working line 22 is higher than the second pressure limit value, further pressure-limiting valve 20 is opened. Working line 22 is then relieved into tank 21. However, if the pressure in working line 22 is lower than the further pressure limit value, further pressure-limiting valve 20 is closed.

If the pressure at second inlet 182 of shuttle valve 18 is higher than the pressure at first inlet 181, shuttle valve 18 connects further pressure medium source 23 to working hydraulic system 3. However, if the pressure at second inlet 182 of shuttle valve 18 is lower than the pressure at first inlet 181, shuttle valve 18 connects accumulator pressure line 16 or working line 22 to working hydraulic system 3.

When clutch 11 is open, drive train 2 and second drive shaft 9 are decoupled. In the decoupled state, drive train 2 and second drive shaft 9 do not exchange any energy. Drive train 2 and the entire hydraulic system therefore do not exchange any energy. Drive train 2 and the hydraulic system are operated independently of each other. Drive train 2 may also be shut off. In this case, first hydraulic pump 12, e.g. from pressure accumulator 15, is operated as a motor that drives second hydraulic pump 13 which supplies the working hydraulic system with pressure medium.

When clutch 11 is closed, drive train 2 is coupled to second drive shaft 9. Energy and torque may therefore be transferred from drive train 2 to second drive shaft 9 or, vice-versa, from second drive shaft 9 to drive train 2. Drive train 2 and the hydraulic system can therefore exchange energy.

Drive system 1 may be operated with clutch 11 open or, as an alternative, with clutch 11 closed, in order to adjust the desired energy flow.

The hydraulic system, which has been decoupled from mechanical drive train 2, may be operated in various decoupled hydraulic system operation modes, which are described below.

In a first decoupled hydraulic system operating mode, energy that has been stored in pressure accumulator 15, and stored pressure medium are both supplied directly to working hydraulic system 3. Accumulator pressure-maintaining valve 24 is positioned in its home position. In its home position, accumulator pressure-maintaining valve 24 is designed as a non-return valve that is open in the direction of pressure accumulator 15. Pressure medium that is stored in pressure accumulator 15, or stored energy therefore do not escape via first hydraulic pump 12. Instead, the pressure from pressure accumulator 15 is applied at pressure-limiting valve 17 on the inlet side. In the first decoupled hydraulic system operating mode, the pressure in pressure accumulator 15 is higher than the first pressure limit value that was set. Pressure-limiting valve 17 is therefore opened. The same pressure is therefore present in working line 22 as in pressure accumulator 15. In the first decoupled hydraulic system operating mode, pressure-limiting valve 20 is closed. The first pressure limit value is lower than the second pressure limit value. The pressure in working line 22 is therefore between the first and second pressure limit values. In the first decoupled hydraulic system operating mode, shuttle valve 18 connects accumulator pressure line 16 and working line 22 to working hydraulic system 3. Pressure accumulator 16 is therefore connected via shuttle valve 18 to working hydraulic system 3. Working hydraulic system 3 may utilize energy from pressure accumulator 15.

In a second decoupled hydraulic system operating mode, energy is supplied to working hydraulic system 3 directly from first pressure accumulator 15. In this second decoupled hydraulic system operating mode, the pressure in pressure accumulator 15 is lower than the first pressure limit value. Pressure-limiting valve 17 is closed. Accumulator pressure-maintaining valve 24 is positioned in its further position via the action of proportional magnet 240. In this further position, accumulator pressure-maintaining valve 24 is unblocked. As a result, first pressure accumulator 15 may be relieved into tank 21 via first hydraulic pump 12, thereby generating a torque. In the second decoupled hydraulic system operating mode, pressure accumulator 15 is relieved into tank 21 via accumulator line 14 and first hydraulic pump 12. The energy stored in first pressure accumulator 15 is output to first hydraulic pump 12 and, from here, it is supplied via second drive shaft 9 to second hydraulic pump 13. Using this energy, second hydraulic pump 13 pumps pressure medium out of tank 21 via working line 22 in the direction of working hydraulic system 3. Accumulator pressure line 16 or working line 22 are connected via shuttle valve 18 to working hydraulic system 3, analogous to the first decoupled hydraulic system operating mode, and under the same conditions.

When clutch 11 is closed, the hydraulic system is coupled to mechanical drive train 2. Drive train 2 and the hydraulic system exchange energy and torque via clutch 11.

In a first coupled hydraulic system operating mode, drive train 2 transfers energy only from diesel engine 5 to the hydraulic system. Energy from diesel engine 5 is transferred to the hydraulic system via transmission unit 6, first drive shaft 7, clutch 11, and gear stage 10 and second drive shaft 9.

In a second coupled hydraulic system operating mode, drive train 2 transfers energy only from rear axle transmission 8 to the hydraulic system. This operating mode exists when the drive system is braked. Kinetic energy is transferred from rear axle transmission 8, due to the inertia of a traveling vehicle, to the hydraulic system via first drive shaft 7, clutch 11, gear stage 10, and second drive shaft 9.

The hydraulic system takes on energy in the first and second coupled hydraulic system operating modes. Second hydraulic pump 13 pumps pressure medium out of tank 21 via working line 22 in the direction of working hydraulic system 3. As a result, second hydraulic pump 13 may pump pressure medium and energy into working hydraulic system 3. First hydraulic pump 12 may be swung out into one of the two opposing directions. First hydraulic pump 12 may therefore pump pressure medium in the direction of pressure accumulator 15, using energy from drive train 2, or in the direction of tank 21, using energy from pressure accumulator 15, and thereby support drive train 2.

First hydraulic pump 12, which is swung out in a first direction, releases pressure medium from pressure accumulator 15 into tank 21, as in decoupled operation. First hydraulic pump 12 drives second hydraulic pump 13 using second drive shaft 9. First hydraulic pump 12 therefore supports the drive of second hydraulic pump 13 using energy from pressure accumulator 15. Simultaneously, energy from drive train 2 and pressure accumulator 15 is supplied to second hydraulic pump 13.

First hydraulic pump 12, which is swung out in a second opposing direction, pumps pressure medium out of tank 21 and into pressure accumulator 15 and/or into accumulator pressure line 16. The delivery volume of first hydraulic pump 12 is adapted to the pressure between first hydraulic pump 12 and accumulator pressure-maintaining valve 24 and the rotational speed of second drive shaft 9. If the pressure in pressure accumulator 15 is higher than the first pressure limit value, pressure-limiting valve 17 is closed. If, in addition, the pressure in first pressure accumulator 15 is higher than the pressure in working line 22, pressure medium flows via pressure-limiting valve 17 in the direction of working hydraulic system 3. Energy from drive train 2 is therefore delivered via second hydraulic pump 12 and pressure-limiting valve 17 to the working hydraulic system. This operating mode may also be implemented without second hydraulic pump 15.

In a third coupled hydraulic system operating mode, drive train 2 transfers energy from the hydraulic system to rear axle transmission 8. In so doing, energy and torque are transferred from second drive shaft 9 to rear axle transmission 8 via gear stage 10, clutch 11, and first drive shaft 7. First hydraulic pump 12, which is swung out in the first direction, releases pressure medium from pressure accumulator 15 into tank 21. First hydraulic pump 12 therefore drives rear axle transmission 8 via second drive shaft 9 using energy from pressure accumulator 15. Second drive shaft 9 may simultaneously pump pressure medium out of tank 21 and into working hydraulic system 3. It is thereby possible to supply rear axle transmission 8 and working hydraulic system 3 with energy from pressure accumulator 15.

If pressure medium is pumped in the direction of pressure accumulator 15, which is already full, pressure-limiting valve 17 and further pressure-limiting valve 20 both open. As a result, the excess pressure medium is returned to tank 21, and hydraulic braking occurs and heat is produced.

By using two hydraulic pumps 12, 13, drive system 1 according to the present invention may supply working hydraulic system 3 with pressures from a further pressure region. Drive system 1 according to the present invention may be easily combined with an auxiliary output as further pressure medium source 23.

FIG. 2 shows a further drive system 100 according to the present invention. Further drive system 100 shown in FIG. 2 is based on drive system 1 depicted in FIG. 1. Only the differences between the two will be discussed in detail below, to prevent unnecessary repetition. Identical elements are labelled with the same reference numerals. Second hydraulic pump 13 is replaced by variable-displacement, second hydraulic pump 13′. The delivery-volume ratio between hydraulic pumps 12 and 13′ may therefore be adjusted in a variable manner using both pumps. In further drive system 100, the connection between first hydraulic pump 12 and tank 21 shown in FIG. 1 is replaced by a further accumulator line 140 that connects first hydraulic pump 12 to a further pressure accumulator 150, instead of to tank 21. For first hydraulic pump 12, further pressure accumulator 150 therefore replaces tank 21. First hydraulic pump 12 is therefore located in a closed circuit. Pressure accumulator 15 is designed as a high-pressure accumulator, and further pressure accumulator 150 is preferably designed as a low-pressure accumulator. Accumulator pressure line 16 and pressure-limiting valve 17 depicted in FIG. 1 are not present in further drive system 100. Instead, working line 22 is connected directly via shuttle valve 18 to working hydraulic system 3. Shuttle valve 18 is installed in working line 22 between replacement branch 220′ and working hydraulic system 3. Replacement branch 220′ replaces branch 220 depicted in FIG. 1. Working line 22 is connected to first input 181. All functions that were described for drive system 1, and that do not require an open pressure-limiting valve 17, may also be implemented using a further drive system 100 in the manner described for drive system 1. Second hydraulic pump 13 is connected via a further suction line 22′ directly to tank 21 and is therefore operated in an open circuit. Due to the location of first pump 12 in the closed circuit, higher rotational speeds are possible, thereby resulting in improved efficiency.

The system for energy management, which is likewise not depicted in FIG. 2, is connected to a second displacment device 130 that is connected to further second hydraulic pump 13′ and adjusts its displacement volume and delivery direction. The system for energy management also activates further second hydraulic pump 13′ via second adjusting device 130. Operation may therefore also be carried out in an optimal manner for second drive system 100.

The hydraulic pumps may be replaced by fixed-delivery pumps. In this case, however, some of the advantageous functions described above are eliminated as a result.

Higher pump rotational speeds are made possible by forming a closed circuit for first hydraulic pump 12. A preload pressure of second pressure accumulator 150, which is higher than the tank pressure, makes it possible to suction a higher volumetric flow when suctioning pressure medium out of second pressure accumulator 150 than when suctioning pressure medium out of tank 21.

The drive systems according to the present invention are suitable for use for garbage trucks, busses, and for delivery vehicles having lifting mechanisms, such as forklifts or wheel loaders.

The present invention is not limited to the embodiments shown. Instead, individual features of the embodiments may be advantageously combined with one another. In particular, second hydraulic pump 13 in the embodiment depicted in FIG. 1 may be eliminated.

What is claimed is:

1. A drive system comprising a travel drive, a working hydraulic system (3), and a device for hydrostatic braking (4) that includes a first hydrostatic piston machine (12) which is connected to a drive train (2) of the travel drive, the first hydrostatic piston machine (12) being connected via an accumulator line (14) to a pressure accumulator (15),
wherein
the accumulator line (14) is connected via an accumulator pressure line (16) to the working hydraulic system (3).

2. The drive system as recited in claim 1,
wherein
the first hydrostatic piston machine (12) is a variable-displacement hydraulic pump.

3. The drive system as recited in claim 2,
wherein
the first hydrostatic piston machine (12) is a hydraulic pump that may be swung out in opposite directions, past a neutral position.

4. The drive system as recited in claim 1,
wherein
a second hydrostatic piston machine (13) that is coupled to the first hydrostatic piston machine (12) is connected via a working pressure line (22) to the working hydraulic system (3).

5. The drive system as recited in claim 1,
wherein
an accumulator pressure-maintaining valve (24) is installed in the accumulator line (14).

6. The drive system as recited in claim 5,
wherein
the accumulator pressure-maintaining valve (24), in its home position, is designed as a non-return valve that is open toward the pressure accumulator (15).

7. The drive system as recited in claim 1,
wherein
a pressure-limiting valve (17) is installed in the accumulator pressure line (16).

8. The drive system as recited in claim 7,
wherein
the pressure-limiting valve (17) is designed as a controllable pressure-limiting valve (17).

9. The drive system as recited in claim 7,
wherein
the accumulator pressure line (16) between the pressure-limiting valve (17) and the working hydraulic system (3) is connected via a tank line (19) to a tank (21), and a further pressure-limiting valve (20) is installed in the tank line (19).

10. The drive system as recited in claim 9,
wherein
the working hydraulic system (3) is connectable via a shuttle valve (18) to the accumulator pressure line (16) or to a further pressure medium source (23), the shuttle valve (18) being connected to the accumulator pressure line (16) between a branch (220) of the tank line (19) and the working hydraulic system (3).

11. The drive system as recited in claim 1,
wherein
the connection of the first piston machine (12) to the drive train (2) may be separated using a clutch (11).

12. The drive system comprising a travel drive, a working hydraulic system (3), and a device for hydrostatic braking (4) that includes a first hydrostatic piston machine (12) which is connected via a clutch (11) to a drive train (2) of the travel drive, and a second hydrostatic piston machine (13) that is mechanically connected to the first hydrostatic piston machine (12), the first hydrostatic piston machine (12) being connected via an accumulator line (14) to a pressure accumulator (15), and the second hydrostatic piston machine (13) being connected via a working line (22) to the working hydraulic system,
wherein
the first hydrostatic piston machine (12) is connected to a further pressure accumulator (150), and the first hydrostatic piston machine (12) is situated in a closed circuit, and the second hydrostatic piston machine (13) is situated in an open circuit.

13. The drive system as recited in claim 11,
wherein
the first hydrostatic piston machine (12) and/or the second hydrostatic piston machine (13) are/is a variable-displacement hydraulic pump.

14. The drive system as recited in claim 12,
wherein
the first hydrostatic piston machine (12) and/or the second hydrostatic piston machine (13) are/is a hydraulic pump that may be swung out in opposite directions, past a neutral position.

15. The drive system as recited in claim 11,
wherein
the pressure accumulator (15) is designed as a high-pressure accumulator, and the further pressure accumulator (150) is designed as a low-pressure accumulator.

16. The drive system as recited in claim 11,
wherein
the working line (22) is connected via a tank line (19) to a tank (21), and a pressure-limiting valve (20) is formed in the tank line (19).

17. The drive system as recited in claim 11,
wherein
the working hydraulic system (3) is connectable via a shuttle valve (18) to the working line (22) or to a further pressure medium source (23), the shuttle valve (18) being connected to the working line (22) between a branch (220′) and the working hydraulic system (3).

18. The drive system as recited in claim 11,
wherein
an accumulator pressure-maintaining valve (24) is installed in the accumulator line (14).

19. The drive system as recited in claim 17,
wherein
the accumulator pressure-maintaining valve (24), in its home position, is designed as a non-return valve that is open toward the pressure accumulator (15).
